(19) United States
(12) Patent Application Publication
(10) Pub. No.: US 2022/0235176 A1
(43) Pub. Date: Jul. 28, 2022

(54) METHOD FOR PRODUCING POLYETHER ESTER CARBONATE POLYOLS

(71) Applicant: Covestro Intellectual Property GmbH & Co. KG, Leverkusen (DE)

(72) Inventors: Thomas Ernst Mueller, Bochum (DE); Christoph Guertler, Köln (DE); Muhammad Afzal Subhani, Aachen (DE); Walter Leitner, Aachen (DE)

(21) Appl. No.: 17/612,413

(22) PCT Filed: Jun. 26, 2020
(86) PCT No.: PCT/EP2020/068044

§ 371 Date: Nov. 18, 2021

(30) Foreign Application Priority Data
Jul. 5, 2019 (EP) 19184775.5

(51) Int. Cl. C08G 64/18; C08G 64/34

(52) U.S. Cl. CPC C08G 64/183; C08G 64/34

(57) ABSTRACT

A method for producing polyether ester carbonate polyols by catalytically adding alkylene oxide and carbon dioxide to an H-functional initiator substance in the presence of a double metal cyanide catalyst. The method comprises the following steps: (α) feeding a partial amount of H-functional initiator substance and/or a suspension agent which does not have any H-functional groups into a reactor, optionally together with DMC catalyst, (γ) adding alkylene oxide and optionally carbon dioxide to the reactor during the reaction. The method is characterized in that in step (γ) lactide is added to the reactor.

### CROSS REFERENCE TO RELATED APPLICATIONS

This application is a U.S. national stage application, filed under 35 U.S.C. § 371, of International Application No. PCT/EP2020/068044, which was filed on Jun. 26, 2020, and which claims priority to European Patent Application No. 19184775.5 which was filed on Jul. 5, 2019. The contents of each are hereby incorporated by reference into this specification.

### FIELD

The present invention relates to a process for preparing polyether ester carbonate polyols by addition of alkylene oxide, lactide and carbon dioxide onto an H-functional starter substance in the presence of a double metal cyanide catalyst. The invention further relates to a polyether ester carbonate polyol obtainable by this process.

### BACKGROUND

The preparation of polyether carbonate polyols by catalytic reaction of alkylene oxides (epoxides) and carbon dioxide in the presence of H-functional starter substances (“starters”) has been the subject of intensive study for more than 40 years (e.g. Inoue et al, Copolymerization of Carbon Dioxide and Epoxide with Organometallic Compounds; Die Makromolekulare Chemie [Macromolecular Chemistry] 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are integers, and where the product shown here in scheme (I) for the polyether carbonate polyol should merely be understood in such a way that blocks having the structure shown may in principle be present in the polyether carbonate polyol obtained, but the sequence, number and length of the blocks and the OH functionality of the starter may vary and is not restricted to the polyether carbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example, when R═CH₃, propylene carbonate).

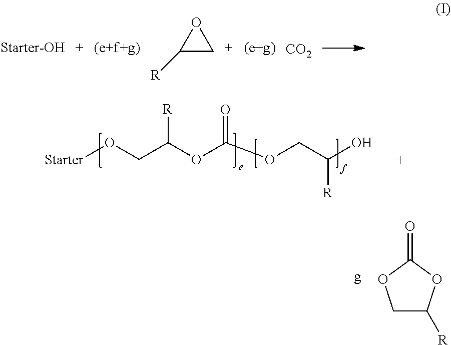

WO 2013/087582 A2 discloses the terpolymerization of propylene oxide, anhydrides and carbon dioxide in the presence of a double metal cyanide catalyst, wherein one or more H-functional starter substances are initially charged in the reactor. Neither lactides nor the viscosity of the obtained polyether ester carbonate polyols are disclosed.

EP 2 604 642 A1 has for its subject matter a process for preparing polyether carbonate polyols by catalytic addition of carbon dioxide and alkylene oxides onto one or more H-functional starter substances in the presence of double metal cyanide (DMC) catalyst, wherein, in a first activation stage, the DMC catalyst and at least one H-functional starter substance are initially charged and, in a second activation stage, the DMC catalyst is activated by addition of at least one alkylene oxide, CO₂ and at least one cyclic anhydride, and, in a third step [polymerization stage], at least one alkylene oxide and CO₂ are added. Neither lactides nor the viscosity of the obtained polyether ester carbonate polyols are disclosed.

WO 2014/033070 A1 discloses a process for preparing polyether carbonate polyols by addition of alkylene oxides and carbon dioxide onto one or more H-functional starter substances in the presence of a double metal cyanide catalyst, wherein a suspension medium containing no H-functional groups and selected from one or more compounds from the group consisting of aliphatic lactones, aromatic lactones, lactides, cyclic carbonates having at least three optionally substituted methylene groups between the oxygen atoms of the carbonate group, aliphatic cyclic anhydrides and aromatic cyclic anhydrides is initially charged in a reactor and one or more H-functional starter substances are continuously metered into the reactor during the reaction. Neither an effect of lactides on the viscosity of the polyether carbonate polyol nor the addition of lactides during the copolymerization is disclosed.

### SUMMARY

It is an object of the present invention to provide a process for preparing polyether ester carbonate polyols in which the resulting polyether ester carbonate polyol has a relatively low viscosity.

The object is achieved by a process for preparing polyether ester carbonate polyols by catalytic addition of alkylene oxide and carbon dioxide onto an H-functional starter substance in the presence of a double metal cyanide catalyst, comprising the steps of:
(α) initially charging a subamount of H-functional starter substance and/or a suspension medium having no H-functional groups into a reactor, optionally together with DMC catalyst,
(γ) metering the alkylene oxide and optionally carbon dioxide into the reactor during the reaction, characterized in that lactide is metered into the reactor in step (γ),

### DETAILED DESCRIPTION

### Step (α):

In the process a subamount of the H-functional starter substance and/or a suspension medium having no H-functional groups may first be initially charged in the reactor. Subsequently, any amount of DMC catalyst required for the polyaddition is added to the reactor. The sequence of addition is not critical. It is also possible to charge the reactor firstly with the DMC catalyst and subsequently with a subamount of H-functional starter substance. It is alternatively also possible first to suspend the DMC catalyst in a subamount of H-functional starter substance and then to charge the reactor with the suspension.

In a preferred embodiment of the invention, in step (α), the reactor is initially charged with an H-functional starter substance, optionally together with DMC catalyst, without including any suspension medium containing no H-functional groups in the initial reactor charge.

The DMC catalyst is preferably used in an amount such that the content of catalyst in the resulting reaction product is 10 to 10 000 ppm, more preferably 20 to 5000 ppm, and most preferably 50 to 500 ppm.

In a preferred embodiment, inert gas (for example argon or nitrogen), an inert gas/carbon dioxide mixture or carbon dioxide is introduced into the resulting mixture of (a) a subamount of H-functional starter substance and (b) DMC catalyst at a temperature of 90° C. to 150° C., more preferably of 100° C. to 140° C., and at the same time a reduced pressure (absolute) of 10 mbar to 800 mbar, more preferably of 50 mbar to 200 mbar, is applied.

In an alternative preferred embodiment, the resulting mixture of (a) a subamount of H-functional starter substance and (b) DMC catalyst is contacted at a temperature of 90° C. to 150° C., more preferably of 100° C. to 140° C., at least once, preferably three times, with 1.5 bar to 10 bar (absolute), more preferably 3 bar to 6 bar (absolute), of an inert gas (for example argon or nitrogen), an inert gas/carbon dioxide mixture or carbon dioxide and then the gauge pressure is in each case reduced to about 1 bar (absolute).

The DMC catalyst can be added in solid form or as a suspension in suspension medium containing no H-functional groups, in H-functional starter substance or in a mixture thereof.

In a further preferred embodiment, in step (α)
(α-I) a subamount of the H-functional starter substances and/or suspension medium is initially charged and
(α-II) the temperature of the subamount of H-functional starter substance is brought to 50° C. to 200° C., preferably 80° C. to 160° C., more preferably 100° C. to 140° C., and/or the pressure in the reactor is lowered to less than 500 mbar, preferably 5 mbar to 100 mbar, wherein an inert gas stream (for example of argon or nitrogen), an inert gas/carbon dioxide stream or a carbon dioxide stream is optionally passed through the reactor, wherein the DMC catalyst is added to the subamount of H-functional starter substance in step (α-I) or immediately thereafter in step (α-II).

The subamount of the H-functional starter substance used in (α) may contain a component K, preferably in an amount of at least 50 ppm, more preferably of 100 to 10 000 ppm.

In a preferred embodiment, step (α) is performed in the absence of lactide.

### Step (β):

Step (β) serves to activate the DMC catalyst. This step may optionally be performed under an inert gas atmosphere, under an atmosphere composed of an inert gas/carbon dioxide mixture or under a carbon dioxide atmosphere. Activation in the context of this invention refers to a step in which a subamount of the alkylene oxide is added to the DMC catalyst suspension at temperatures of 90° C. to 150° C. and then the addition of the alkylene oxide is stopped, with observation of evolution of heat caused by a subsequent exothermic chemical reaction, which can lead to a temperature peak (“hotspot”), and of a pressure drop in the reactor caused by the conversion of alkylene oxide and possibly CO₂. The process step of activation is the period from addition of the subamount of alkylene oxide, optionally in the presence of CO₂, to the DMC catalyst until evolution of heat occurs. Optionally, the subamount of the alkylene oxide can be added to the DMC catalyst in a plurality of individual steps, optionally in the presence of CO₂, and then the addition of the alkylene oxide can be stopped in each case. In this case, the process step of activation comprises the period from the addition of the first subamount of alkylene oxide, optionally in the presence of CO₂, to the DMC catalyst until the occurrence of the evolution of heat after addition of the last portion of alkylene oxide. In general, the activation step may be preceded by a step for drying the DMC catalyst and optionally the H-functional starter substance at elevated temperature and/or reduced pressure, optionally with passage of an inert gas through the reaction mixture.

The alkylene oxide (and optionally the carbon dioxide) can in principle be metered in in different ways. The metered addition can be commenced from the vacuum or at a previously chosen supply pressure. The supply pressure is preferably established by introducing an inert gas (for example nitrogen or argon) or carbon dioxide, wherein the (absolute) pressure is 5 mbar to 100 bar, by preference 10 mbar to 50 bar and preferably 20 mbar to 50 bar.

In one preferred embodiment, the amount of the alkylene oxide used in the activation in step (β) is 0.1% to 25.0% by weight, preferably 1.0% to 20.0% by weight, particularly preferably 2.0% to 16.0% by weight (based on the amount of H-functional starter substance used in step (α)). The alkylene oxide can be added in one step or in two or more portions. Preferably, addition of a portion of the alkylene oxide is followed by interruption of the addition of the alkylene oxide until the occurrence of evolution of heat, and only then is the next portion of alkylene oxide added. Preference is also given to a two-stage activation (step β), wherein
(β1) in a first activation stage addition of a first subamount of alkylene oxide is effected under an inert gas atmosphere or a carbon dioxide atmosphere and
(β2) in a second activation stage addition of a second subamount of alkylene oxide is effected under a carbon dioxide atmosphere.

### Step (γ):

The metered addition of the H-functional starter substance, the alkylene oxide, the lactide and optionally of the carbon dioxide may be carried out simultaneously or sequentially (portionwise). It is preferable when the metering of H-functional starter substance into the reactor during the reaction is effected continuously, and alkylene oxide, lactide and optionally carbon dioxide are metered into the reactor simultaneously or sequentially (portionwise) during the reaction. It is particularly preferable when the metering of H-functional starter substance, alkylene oxide, lactide and carbon dioxide into the reactor during the reaction is effected simultaneously and continuously. For example, the total amount of carbon dioxide, the amount of H-functional starter substance and/or the amount of alkylene oxide and lactide metered in in step (γ) may be added at once or continuously. The term “continuously” used here can be defined as a mode of addition of a reactant such that a concentration of the reactant effective for the copolymerization is maintained, meaning that the metered addition can be effected, for example, with a constant metering rate, with a varying metering rate or in portions.

The term “copolymerization” is understood in the context of the present invention to mean the polymerization of at least two different monomeric compounds, i.e. including the polymerization of three different monomers, which is referred to universally as “terpolymerization”, or else the polymerization of four or more different monomers.

It is possible, during the addition of alkylene oxide, lactide and/or H-functional starter substance, to increase or lower the CO₂ pressure gradually or stepwise or to leave it constant. The total pressure is preferably kept constant during the reaction by metered addition of further carbon dioxide. The metered addition of alkylene oxide and/or H-functional starter substance is effected simultaneously or sequentially with respect to the metered addition of carbon dioxide.

It is possible to effect metered addition of the alkylene oxide and/or lactide at a constant metering rate or to increase or reduce the metering rate gradually or stepwise or to add the alkylene oxide and/or lactide in portions. Alkylene oxide and/or lactide are preferably added to the reaction mixture at a constant metering rate. If two or more alkylene oxides and/or lactides are used for synthesis of the polyether ester carbonate polyols, the alkylene oxides and/or the lactides may be metered in individually or as a mixture.

The addition of alkylene oxide and lactide is preferably effected via separate metering sites. However, it is also possible to meter in a mixture of alkylene oxide and lactide. The metered addition of alkylene oxide/H-functional starter substance may be effected simultaneously or sequentially via separate feeds (additions) in each case or via one or more feeds, wherein the alkylene oxides/the H-functional starter substances may be metered in individually or as a mixture. It is possible via the manner and/or sequence of the metered addition of H-functional starter substance, alkylene oxide, lactide and/or carbon dioxide to synthesize random, alternating, block or gradient polyether ester carbonate polyols.

In a preferred embodiment, in step (γ) the metered addition of H-functional starter substance is terminated prior to the addition of alkylene oxide and/or lactide.

It is preferable to use an excess of carbon dioxide based on the calculated amount of carbon dioxide incorporated in the polyether ester carbonate polyol, since an excess of carbon dioxide is advantageous because of the inertness of carbon dioxide. The amount of carbon dioxide may be determined via the total pressure under the particular reaction conditions. An advantageous total pressure (absolute) for the copolymerization for preparing the polyether ester carbonate polyols has been found to be in the range from 0.01 to 120 bar, preferably 0.1 to 110 bar, more preferably from 1 to 100 bar. The carbon dioxide may be supplied continuously or discontinuously. This depends on how quickly the alkylene oxides are consumed and on whether the product is to include any CO₂-free polyether blocks. The amount of the carbon dioxide (reported as pressure) can likewise be varied during addition of the alkylene oxides. CO₂ may also be added to the reactor as a solid and then converted under the selected reaction conditions into the gaseous, dissolved, liquid and/or supercritical state.

A preferred embodiment of the process according to the invention is inter alia characterized in that in step (γ) the total amount of H-functional starter substance is added. This addition may be effected at a constant metered addition rate, at a varying metered addition rate or portionwise.

For the process of the invention, it has additionally been found that the copolymerization (step (γ)) for preparation of the polyether ester carbonate polyols is conducted advantageously at 50° C. to 150° C., preferably at 60° C. to 145° C., more preferably at 70° C. to 140° C. and most preferably at 90° C. to 130° C. If temperatures are set below 50° C., the reaction generally becomes very slow. At temperatures above 150° C., the amount of unwanted by-products rises significantly.

The metered addition of alkylene oxide, lactide, H-functional starter substance and DMC catalyst may be effected via separate or combined feed points. In a preferred embodiment, alkylene oxide and H-functional starter substance are continuously supplied to the reaction mixture via separate feed points. This addition of the H-functional starter substance can be effected in the form of a continuous metered addition to the reactor or portionwise.

Steps (α), (β) and (γ) may be performed in the same reactor or may each be performed separately in different reactors. Particularly preferred reactor types are: tubular reactors, stirred tanks, loop reactors.

Polyether ester carbonate polyols may be prepared in a stirred tank, the stirred tank being cooled via the reactor jacket, internal cooling surfaces and/or cooling surfaces within a pumped circulation circuit, depending on the embodiment and mode of operation. Both in the semi-batch application, where the product is withdrawn only once the reaction has ended, and in the continuous application, where the product is withdrawn continuously, particular attention should be paid to the metered addition rate of the alkylene oxide. Said rate should be adjusted such that despite the inhibiting effect of the carbon dioxide the alkylene oxides react sufficiently rapidly. The concentration of free alkylene oxide in the reaction mixture during the activation step (step β) is preferably >0% to 100% by weight, more preferably >0% to 50% by weight, most preferably >0% to 20% by weight (based in each case on the weight of the reaction mixture). The concentration of free alkylene oxide in the reaction mixture during the reaction (step γ) is preferably >0% to 40% by weight, more preferably >0% to 25% by weight, most preferably >0% to 15% by weight (based in each case on the weight of the reaction mixture).

In a preferred embodiment, the activated DMC catalyst/suspension medium mixture that results from steps (α) and (β) is further reacted in the same reactor with alkylene oxide, H-functional starter substance and carbon dioxide. In a further preferred embodiment, the activated DMC catalyst/suspension medium mixture that results from steps (α) and (β) is further reacted with alkylene oxide, H-functional starter substance and carbon dioxide in another reaction vessel (for example a stirred tank, a tubular reactor or a loop reactor).

When conducting the reaction in a tubular reactor the activated catalyst/suspension medium mixture that results from steps (α) and (β), H-functional starter substance, alkylene oxide and carbon dioxide are continuously pumped through a tube. The molar ratios of the co-reactants are varied according to the desired polymer. In a preferred embodiment, carbon dioxide is metered in in its liquid or supercritical form to achieve optimal miscibility of the components. It is advantageous to install mixing elements for better mixing of the co-reactants, such as are marketed for example by Ehrfeld Mikrotechnik BTS GmbH, or mixer-heat exchanger elements which simultaneously improve mixing and heat removal.

It is likewise possible to employ loop reactors for preparation of polyether ester carbonate polyols. These generally include reactors with recycling, for example a jet loop reactor, which can also be operated continuously, or a loop-shaped tubular reactor with suitable apparatuses for circulation of the reaction mixture or a loop of a plurality of serially connected tubular reactors. The use of a loop reactor is thus advantageous especially because backmixing can be achieved here, such that it is possible to keep the concentration of free alkylene oxide in the reaction mixture within the optimal range, preferably in the range from >0% to 40% by weight, more preferably >0% to 25% by weight, most preferably >0% to 15% by weight (based in each case on the weight of the reaction mixture).

The polyether ester carbonate polyols are preferably prepared in a continuous process which comprises both a continuous copolymerization and a continuous addition of H-functional starter substance.

The invention therefore also provides a process wherein, in step (γ), H-functional starter substance, alkylene oxide, lactide and DMC catalyst are continuously metered into the reactor in the presence of carbon dioxide (“copolymerization”) and wherein the resulting reaction mixture (containing the reaction product) is continuously removed from the reactor. It is preferable when in step (γ) the DMC catalyst is continuously added in the form of a suspension in H-functional starter substance.

For example, for the continuous process for preparing the polyether ester carbonate polyols in steps (α) and (β), an activated DMC catalyst/suspension medium mixture is prepared, then, in step (γ),
(γ1) a subamount each of H-functional starter substance, alkylene oxide and carbon dioxide are metered in to initiate the copolymerization and
(γ2) during the progress of the copolymerization, the remaining amount of each of DMC catalyst, H-functional starter substance, alkylene oxide and lactide is metered in continuously in the presence of carbon dioxide, with simultaneous continuous removal of resulting reaction mixture from the reactor.

In step (γ), the DMC catalyst is preferably added in the form of a suspension in H-functional starter substance, the amount preferably being chosen such that the content of DMC catalyst in the resulting reaction product is 10 to 10 000 ppm, more preferably 20 to 5000 ppm, and most preferably 50 to 500 ppm.

It is preferable when steps (α) and (β) are performed in a first reactor, and the resulting reaction mixture is then transferred into a second reactor for the copolymerization of step (γ). However, it is also possible to perform steps (α), (β) and (γ) in one reactor.

It has also been found that the process of the present invention can be used for preparation of large amounts of the polyether ester carbonate polyol, wherein a DMC catalyst activated according to steps (α) and (β) in a suspension medium is initially used, and the DMC catalyst is added without prior activation during the copolymerization (γ).

A particularly advantageous feature of the preferred embodiment of the present invention is thus the ability to use “fresh” DMC catalysts without activation for the portion of DMC catalyst which is added continuously in step (γ). An activation of DMC catalysts to be performed analogously to step (β) entails not just additional attention from the operator, thus resulting in an increase in manufacturing costs, but also requires a pressure reaction vessel, thus also resulting in an increase in the capital costs in the construction of a corresponding production plant. Here, “fresh” catalyst is defined as unactivated DMC catalyst in solid form or in the form of a slurry in a suspension medium or an H-functional starter substance. The ability of the present process to use fresh unactivated DMC catalyst in step (γ) enables significant savings in the commercial preparation of polyether ester carbonate polyols and is a preferred embodiment of the present invention.

The term “continuously” used here can be defined as the mode of addition of a relevant catalyst or reactant such that an effective concentration of the DMC catalyst or the reactant is maintained in an essentially continuous manner Catalyst feeding may be effected in a truly continuous manner or in relatively tightly spaced increments. Equally, continuous starter addition may be effected in a truly continuous manner or in increments. There would be no departure from the present process in adding a DMC catalyst or reactants incrementally such that the concentration of the materials added drops essentially to zero for a period of time before the next incremental addition. However, it is preferable for the DMC catalyst concentration to be kept substantially at the same concentration during the main portion of the course of the continuous reaction, and for starter substance to be present during the main portion of the copolymerization process. Incremental addition of DMC catalyst and/or reactant that does not significantly affect the characteristics of the product is nevertheless “continuous” in the sense in which the term is used here. It is possible, for example, to provide a recycling loop in which a portion of the reacting mixture is recycled to a prior point in the process, thus smoothing out discontinuities caused by incremental additions.

### Step (δ)

In an optional step (δ) the reaction mixture continuously removed in step (γ) which generally has an alkylene oxide content of from 0.05% by weight to 10% by weight may be transferred into a postreactor in which, by way of a postreaction, the content of free alkylene oxide is reduced to less than 0.05% by weight in the reaction mixture. The postreactor may be a tubular reactor, a loop reactor or a stirred tank for example.

The pressure in this postreactor is preferably at the same pressure as in the reaction apparatus in which reaction step (γ) is performed. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor is preferably 50° C. to 150° C. and more preferably 80° C. to 140° C.

Suitable suspension media having no H-functional groups are all polar aprotic, weakly polar aprotic and nonpolar aprotic solvents, none of which contain any H-functional groups. Suspension media used may also be a mixture of two or more of these suspension media. Mention is made by way of example at this point of the following polar aprotic solvents: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride.

Preferably employed suspension media are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

In the context of the invention lactides are cyclic compounds containing two or more ester bonds in the ring, preferably compounds of formula (II),

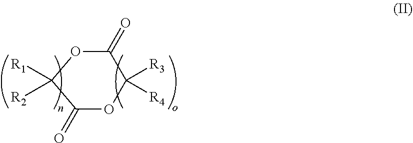

wherein R1, R2, R3 and R4 independently represent hydrogen, a linear or branched C1 to C22 alkyl radical optionally containing heteroatoms, a linear or branched, mono- or polyunsaturated C1 to C22 alkenyl radical optionally containing heteroatoms or an optionally mono- or polysubstituted C6 to C18 aryl radical optionally containing heteroatoms, or may be members of a saturated or unsaturated 4- to 7-membered ring or polycyclic ring system optionally containing heteroatoms and/or ether groups,
and n and o are each independently an integer greater than or equal to 1, preferably 1, 2, 3 or 4, and R1 and R2 in repeat units (n>1) and R3 and R4 in repeat units (o>1) may each be different.

Preferred compounds of formula (II) are 1,4-dioxane-2,5-dione, (S,S)-3,6-dimethyl-1,4-dioxane-2,5-dione, (R,R)-3,6-dimethyl-1,4-dioxane-2,5-dione, meso-3,6-dimethyl-1,4-dioxane-2,5-dione and 3-methyl-1,4-dioxane-2,5-dione, 3-hexyl-6-methyl-1,4-dioxane-2,5-dione, 3,6-di(but-3-en-1-yl)-1,4-dioxane-2,5-dione (in each case including optically active forms). (S,S)-3,6-dimethyl-1,4-dioxane-2,5-dione is particularly preferred.

The lactide is employed in the process according to the invention in an amount of preferably 5% to 40% by weight, more preferably 5% to 30% by weight, especially preferably 10% to 30% by weight, in each case based on the total amount of employed alkylene oxide.

As alkylene oxides the process according to the invention may generally employ alkylene oxides having 2-24 carbon atoms. The alkylene oxides having 2-24 carbon atoms are, for example, ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably employed alkylene oxides are ethylene oxide and/or propylene oxide, more preferably propylene oxide.

Suitable H-functional starter substances (“starters”) that may be used are compounds having alkoxylation-active hydrogen atoms and having a molar mass of 18 to 4500 g/mol, preferably of 62 to 500 g/mol and more preferably of 62 to 182 g/mol. The ability to use a starter having a low molar mass is a distinct advantage over the use of oligomeric starters prepared by means of a preceding oxyalkylation. In particular an economic viability is achieved which is made possible by the omission of a separate oxyalkylation process.

Alkoxylation-active groups having active H atoms are, for example, —OH, —NH₂ (primary amines), —NH— (secondary amines), —SH, and —CO₂H, preferably —OH and —NH₂, more preferably —OH. H— functional starter substance used are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. The C1-C24 alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Monofunctional starter substances that may be employed include alcohols, amines, thiols and carboxylic acids. Monofunctional alcohols that may be used include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are for example dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, in particular castor oil), and all modification products of these abovementioned alcohols with different amounts of ε-caprolactone.

The H-functional starter substances may also be selected from the substance class of the polyether polyols having a molecular weight Mₙ in the range from 18 to 4500 g/mol and a functionality of 2 to 3. Preference is given to polyether polyols formed from repeating ethylene oxide and propylene oxide units, preferably having a proportion of propylene oxide units of 35% to 100%, more preferably having a proportion of propylene oxide units of 50% to 100%. These may be random copolymers, gradient copolymers, alternating copolymers or block copolymers of ethylene oxide and propylene oxide.

The H-functional starter substances may also be selected from the substance class of the polyester polyols. At least bifunctional polyesters are used as the polyester polyols. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. If the alcohol components used are dihydric or polyhydric polyether polyols, the result is polyester ether polyols which can likewise serve as starter substances for preparation of the polyether ester carbonate polyols.

In addition, H-functional starter substances used may be polycarbonate diols which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177.

In a further embodiment of the invention, it is possible to use polyether ester carbonate polyols as H-functional starter substances. Used in particular are polyether ester carbonate polyols obtainable by the process according to the invention described here. To this end, these polyether ester carbonate polyols used as H-functional starter substances are prepared beforehand in a separate reaction step.

The H-functional starter substances generally have a functionality (i.e. the number of polymerization-active H atoms per molecule) of 1 to 8, preferably of 2 or 3. The H-functional starter substances are used either individually or as a mixture of at least two H-functional starter substances.

It is particularly preferable when the H-functional starter substances are one or more compounds selected from the group consisting of ethylene glycol, propane-1,2-diol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol and polyether polyols having a molecular weight Mn in the range from 150 to 4500 g/mol and a functionality of 2 to 3.

The polyether ester carbonate polyols are prepared by catalytic addition of carbon dioxide, lactide and alkylene oxide onto an H-functional starter substance. In the context of the invention “H-functional” is understood to mean the number of alkoxylation-active hydrogen atoms per molecule of the starter substance.

DMC catalysts for use in the homopolymerization of alkylene oxides are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and enable the preparation of polyether ester carbonate polyols at very low catalyst concentrations, such that a removal of the catalyst from the finished product is generally no longer required. A typical example is that of the highly active DMC catalysts described in EP-A 700 949 which contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts according to the invention are preferably obtained by
(i) reacting an aqueous solution of a metal salt with the aqueous solution of a metal cyanide salt in the presence of one or more organic complex ligands, e.g. an ether or alcohol, in a first step,
(ii) removing the solid from the suspension obtained from (i) by known techniques (such as centrifugation or filtration) in a second step,
(iii) optionally washing the isolated solid with an aqueous solution of an organic complex ligand (for example by resuspending and subsequent reisolating by filtration or centrifugation) in a third step,
(iv) and subsequently drying the solid obtained at temperatures of in general 20-120° C. and at pressures of in general 0.1 mbar to atmospheric pressure (1013 mbar), optionally after pulverizing,
   wherein in the first step or immediately after the precipitation of the double metal cyanide compound (second step) one or more organic complex ligands, preferably in excess (based on the double metal cyanide compound), and optionally further complex-forming components are added.

The double metal cyanide compounds present in the DMC catalysts according to the invention are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and dimethoxyethane (glyme) or tert-butanol (preferably in excess based on zinc hexacyanocobaltate) is then added to the suspension formed.

Metal salts suitable for preparation of the double metal cyanide compounds preferably have the general formula (III)

M(X)ₙ (III)

wherein
M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
n is 1 when X=sulfate, carbonate or oxalate and
n is 2 when X=halide, hydroxide, carboxylate, cyanate, thiocyanate, isocyanate, isothiocyanate or nitrate,
or suitable metal salts have the general formula (IV)

Mᵣ(X)₃ (IV)

wherein
M is selected from the metal cations Fe³⁺, Al³⁺, Co³⁺ and Cr³⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
r is 2 when X=sulfate, carbonate or oxalate and
r is 1 when X=halide, hydroxide, carboxylate, cyanate, thiocyanate, isocyanate, isothiocyanate or nitrate,
or suitable metal salts have the general formula (V)

M(X)ₛ (V)

wherein
M is selected from the metal cations Mo⁴⁺, V⁴⁺ and W⁴⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
s is 2 when X=sulfate, carbonate or oxalate and
s is 4 when X=halide, hydroxide, carboxylate, cyanate, thiocyanate, isocyanate, isothiocyanate or nitrate,
or suitable metal salts have the general formula (VI),

M(X)ₜ (VI)

wherein
M is selected from the metal cations Mo⁶⁺ and W⁶⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
t is 3 when X=sulfate, carbonate or oxalate and
t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VII)

(Y)ₐM′(CN)_{b}(A)_{c} (VII)

wherein
M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),
Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),
A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and
a, b and c are integers, wherein the values for a, b and c are selected so as to ensure the electroneutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the inventive DMC catalysts are compounds of the general formula (VIII)

Mₓ[M′ₓ,(CN)_{y}]_{z} (VIII)

in which M is defined as in formula (III) to (VI) and
M′ is as defined in formula (VII), and
x, x′, y and z are integers and are selected such as to ensure the electroneutrality of the double metal cyanide compound.

It is preferable when

x=3, x′=1, y=6 and z=2,

### M=Zn(II), Fe(II), Co(II) or Ni(II) and

### M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms, such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). Most preferred organic complex ligands are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally employed in the preparation of the DMC catalysts according to the invention are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acids or salts, esters or amides thereof, cyclodextrins, phosphorus compounds, α,β-unsaturated carboxylic esters or ionic surface- or interface-active compounds.

In the preparation of the DMC catalysts according to the invention in the first step the aqueous solutions of the metal salt (e.g. zinc chloride), preferably employed in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are reacted in the presence of the organic complex ligand (e.g. tert-butanol) to form a suspension comprising the double metal cyanide compound (e.g. zinc hexacyanocobaltate), water, excess metal salt and the organic complex ligand.

The organic complex ligand may be present in the aqueous solution of the metal salt and/or of the metal cyanide salt or it is added directly to the suspension obtained after precipitation of the double metal cyanide compound. It has proven advantageous to mix the metal salt and metal cyanide salt aqueous solutions and the organic complex ligand by stirring vigorously. Optionally, the suspension formed in the first step is subsequently treated with a further complex-forming component. The complex-forming component is preferably employed in a mixture with water and organic complex ligand. A preferred process for performing the first step (i.e. the preparation of the suspension) is effected using a mixing nozzle, particularly preferably using a jet disperser, as described in WO-A 01/39883.

In the second step, the solid (i.e. the precursor of the catalyst of the invention) is isolated from the suspension by known techniques, such as centrifugation or filtration.

In a preferred embodiment variant, the isolated solid is subsequently washed in a third process step with an aqueous solution of the organic complex ligand (for example by resuspension and subsequent reisolation by filtration or centrifugation). This makes it possible to remove, for example, water-soluble by-products such as potassium chloride from the catalyst according to the invention. The amount of the organic complex ligand in the aqueous wash solution is preferably between 40% and 80% by weight, based on the overall solution.

A further complex-forming component is optionally added to the aqueous wash solution in the third step, preferably in the range between 0.5% and 5% by weight, based on the overall solution.

It is also advantageous to wash the isolated solid more than once. Preferably, in a first washing step (iii-1), an aqueous solution of the unsaturated alcohol is used for washing (for example by resuspension and subsequent reisolation by filtration or centrifugation), in order in this way to remove, for example, water-soluble by-products such as potassium chloride from the inventive catalyst. The amount of the unsaturated alcohol in the aqueous washing solution is particularly preferably between 40% and 80% by weight, based on the overall solution of the first washing step. In the further washing steps (iii-2), either the first washing step is repeated one or more times, preferably one to three times, or, preferably, a nonaqueous solution, for example a mixture or solution of unsaturated alcohol and further complex-forming component (preferably in the range between 0.5% and 5% by weight, based on the total amount of the wash solution in step (iii-2)), is used as a washing solution, and the solid is washed with it one or more times, preferably one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts according to the invention from the suspension by filtration, filtercake washing and drying is described in WO-A 01/80994.

The present invention further provides a polyether ester carbonate polyol obtainable by the process of the invention.

The polyether ester carbonate polyols obtained in accordance with the invention have a functionality of, for example, at least 1, preferably of 1 to 8, more preferably of 1 to 6 and most preferably of 2 to 4. The molecular weight is preferably 400 to 10 000 g/mol and more preferably 500 to 6000 g/mol.

The polyether ester carbonate polyols obtainable by the process according to the invention have a low content of by-products and a low viscosity and are readily processable, especially by reaction with di- and/or polyisocyanates to afford polyurethanes, in particular flexible polyurethane foams such as for example slabstock flexible polyurethane foams and molded flexible polyurethane foams. For polyurethane applications, it is preferable to use polyether ester carbonate polyols based on an H-functional starter substance having a functionality of at least 2. In addition, the polyether ester carbonate polyols obtainable by the process according to the invention may be used in applications such as washing and cleaning composition formulations, drilling fluids, fuel additives, ionic and nonionic surfactants, lubricants, process chemicals for papermaking or textile manufacture, or cosmetic formulations. The person skilled in the art is aware that, depending on the respective field of use, the polyether ester carbonate polyols to be used have to fulfill certain material properties, for example molecular weight, viscosity, functionality and/or hydroxyl number.

In a first embodiment, the invention relates to a process for preparing polyether ester carbonate polyols by catalytic addition of alkylene oxide and carbon dioxide onto an H-functional starter substance in the presence of a double metal cyanide catalyst, comprising the steps of:
(α) initially charging a subamount of H-functional starter substance and/or a suspension medium having no H-functional groups into a reactor, optionally together with DMC catalyst,
(γ) metering the alkylene oxide and optionally carbon dioxide into the reactor during the reaction, characterized in that lactide is metered into the reactor in step (γ),

In a second embodiment, the invention relates to a process according to the first embodiment, characterized in that step (α) is carried out in the absence of lactide

In a third embodiment, the invention relates to a process according to embodiment 1 or 2, characterized in that the lactide is employed in an amount of 5% by weight to 40% by weight based on the total amount of employed alkylene oxide.

In a fourth embodiment, the invention relates to a process according to embodiment 1 or 2, characterized in that the lactide is employed in an amount of 10% by weight to 30% by weight based on the total amount of employed alkylene oxide.

In a fifth embodiment, the invention relates to a process according to any of embodiments 1 to 4, characterized in that following step (α)
(β) a portion of alkylene oxide is added to the mixture from step (α) at temperatures of 90° C. to 150° C. and the addition of the alkylene oxide compound and/or the lactide is subsequently interrupted, wherein step (β) is especially performed under an inert gas atmosphere, under an atmosphere of an inert gas-carbon dioxide mixture or under a carbon dioxide atmosphere.

In a sixth embodiment, the invention relates to a process according to any of embodiments 1 to 5, characterized in that in step (γ) the H-functional starter substance, the alkylene oxide and the lactide are continuously metered into the reactor in the presence of carbon dioxide.

In a seventh embodiment, the invention relates to a process according to any of embodiments 1 to 6, characterized in that in step (γ) the metered addition of the H-functional starter substances is terminated prior to the addition of the alkylene oxide and/or of the lactide.

In an eighth embodiment, the invention relates to a process according to any of embodiments 1 to 7, characterized in that in step (γ) H-functional starter substance, alkylene oxide, lactide and double metal cyanide catalyst are continuously metered into the reactor and the resulting reaction mixture is continuously removed from the reactor.

In a ninth embodiment, the invention relates to a process according to embodiment 8, characterized in that the double metal cyanide catalyst is continuously added in the form of a suspension in H-functional starter substance.

In a tenth embodiment, the invention relates to a process according to embodiment 8 or 9, characterized in that in a step (δ) downstream of step (γ) the reaction mixture removed continuously in step (γ) having an alkylene oxide content of 0.05% to 10% by weight is transferred into a postreactor and therein subjected to a postreaction, thus reducing the content of free alkylene oxide to less than 0.05% by weight in the reaction mixture

In an eleventh embodiment, the invention relates to a process according to any of embodiments 1 to 10, characterized in that the lactide employed is at least one compound of formula (II),

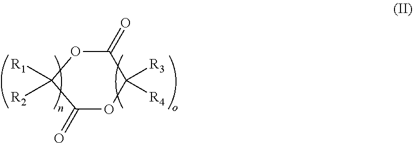

wherein R1, R2, R3 and R4 independently represent hydrogen, a linear or branched C1 to C22 alkyl radical optionally containing heteroatoms, a linear or branched, mono- or polyunsaturated C1 to C22 alkenyl radical optionally containing heteroatoms or an optionally mono- or polysubstituted C6 to C18 aryl radical optionally containing heteroatoms, or may be members of a saturated or unsaturated 4- to 7-membered ring or polycyclic ring system optionally containing heteroatoms and/or ether groups,
and n and o independently represent an integer of not less than 1, preferably 1, 2, 3 or 4, and R1 and R2 in repeating units (n>1) and R3 and R4 in repeating units (o>1) may each be different.

In a twelfth embodiment, the invention relates to a process according to any of embodiments 1 to 10, characterized in that the lactide is at least one compound selected from the group consisting of 1,4-dioxane-2,5-dione, (S,S)-3,6-dimethyl-1,4-dioxane-2,5-dione, (R,R)-3,6-dimethyl-1,4-dioxane-2,5-dione, me so-3,6-dimethyl-1,4-dioxane-2,5-dione and 3-methy 1-1,4-dioxane-2,5-dione, 3-hexyl-6-methyl-1,4-dioxane-2,5-dione, 3,6-di(but-3-en-1-yl)-1,4-dioxane-2,5-dione (in each case including optically active forms).

In a thirteenth embodiment the invention relates to a process according to any of embodiments 1 to 12, characterized in that the H-functional starter substance is selected from the group comprising or consisting of alcohols, amines, thiols, amino alcohols, thio alcohols, hydroxy esters, polyether polyols, polyester polyols, polyester ether polyols, polycarbonate polyols, polyether carbonate polyols, polyethyleneimines, polyetheramines, polytetrahydrofurans, polyether thiols, polyacrylate polyols, castor oil, the mono- or diglyceride of castor oil, monoglycerides of fatty acids, chemically modified mono-, di- and/or triglycerides of fatty acids and C1-C24-alkyl fatty acid esters containing on average at least 2 OH groups per molecule.

In a fourteenth embodiment, the invention relates to a process according to any of embodiments 1 to 12, characterized in that the H-functional starter substance is selected from the group comprising or consisting of ethylene glycol, propane-1,2-diol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, di- and trifunctional polyether polyols or mixtures thereof, wherein the polyether polyol has been formed from a di- or tri-H-functional starter substance and propylene oxide or a di- or tri-H-functional starter substance, propylene oxide and ethylene oxide and the polyether polyol especially has a molecular weight Mₙ in the range from 62 to 4500 g/mol and a functionality of 2 to 3.

### EXAMPLES

### Input Materials

PET-I: difunctional poly(oxypropylene)polyol having an OH number of 112 mg_{KOH}/g
PO: Propylene oxide
Lactide: 3,6-dimethyl-1,4-dioxane-2,5-dione
MA: maleic anhydride
DMC catalyst was prepared according to Example 6 in WO 01/80994 A1

### Methods

The terpolymerization of propylene oxide, lactide and CO₂ resulted not only in the cyclic propylene carbonate but also in the polyether ester carbonate polyol containing both the polycarbonate units shown in formula (IXa)

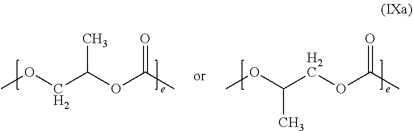

and the polyether units shown in formula (IXb).

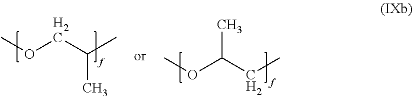

The reaction mixture was characterized by ¹H-NMR spectroscopy.

The ratio of the amount of cyclic propylene carbonate to polyether ester carbonate polyol (selectivity; ratio g/e) and also the fraction of unconverted monomers (propylene oxide R_{PO}, lactide R_{lactide} in mol %) were determined by ¹H-NMR spectroscopy. To this end a sample of the reaction mixture obtained after the reaction was in each case dissolved in deuterated chloroform and analyzed on a Bruker spectrometer (AV400, 400 MHz).

Subsequently, the reaction mixture was diluted with dichloromethane (20 ml) and the solution was passed through a falling-film evaporator. The solution (0.1 kg in 3 h) ran downwards along the inner wall of a tube of diameter 70 mm and length 200 mm which had been heated externally to 120° C., in the course of which the reaction mixture was distributed homogeneously as a thin film on the inner wall of the falling-film evaporator in each case by three rollers of diameter 10 mm rotating at a speed of 250 rpm. Within the tube, a pump was used to set a pressure of 3 mbar. The reaction mixture purified of volatile constituents (unconverted epoxides, cyclic carbonate, solvent) was collected in a receiver at the lower end of the heated tube.

The molar ratio of carbonate groups to ether groups in the polyether ester carbonate polyol (ratio e/f) and also the molar proportion of lactide incorporated into the polymer were determined by means of ¹H-NMR spectroscopy. To this end a sample of the purified reaction mixture was in each case dissolved in deuterated chloroform and analyzed on a spectrometer from Bruker (AV400, 400 MHz). The relevant resonances in the ¹H NMR spectrum (based on TMS=0 ppm) which were used for integration are as follows:
I1: 1.10-1.17 ppm: CH₃ of polyether units, area of resonance corresponds to three hydrogen atoms,
I2: 1.25-1.34 ppm: CH₃ of polycarbonate units, area of resonance corresponds to three hydrogen atoms,
I3: 4.48-4.58 ppm: CH of cyclic carbonate, area of resonance corresponds to one hydrogen atom,
I4: 2.95-3.00 ppm: CH group for free, unreacted propylene oxide, area of resonance corresponds to one hydrogen atom.
I5: 1.36-1.54 ppm: CH₃ of poly lactide units, area of resonance corresponds to six hydrogen atoms,
I6: 1.59-1.62 ppm: CH₃ for free, unreacted lactide, area of resonance corresponds to six hydrogen atoms,
I7: 6.22-6.29 ppm: CH group of the double bond obtained in the polymer via the incorporation of maleic anhydride, resonance area corresponds to two hydrogen atoms,
I8: 7.05 ppm: CH group for free, unreacted maleic anhydride, resonance area corresponds to two hydrogen atoms.

The figures reported are the molar ratio of the amount of cyclic propylene carbonate to carbonate units in the polyether ester carbonate polyol (selectivity, g/e) and the molar ratio of carbonate groups to ether groups in the polyether ester carbonate polyol (elf) and also the proportions of unconverted propylene oxide (in mol %) and lactide (in mol %).

Taking into account the relative intensities the values were calculated as follows for the following cases:

Polyether ester carbonate polyol A: Polyols obtained by terpolymerization of propylene oxide, carbon dioxide and lactide
Polyether ester carbonate polyol B: Polyols obtained by terpolymerization of propylene oxide, carbon dioxide and maleic anhydride
Molar ratio of the amount of cyclic propylene carbonate to carbonate units in the polyether ester carbonate polyol (selectivity g/e):

$$Selectivity g / e = [ I 3 / ( \frac{I 2}{3} ) ] \qquad ( X )$$

Molar ratio of carbonate groups to ether groups in the polyether ester carbonate polyol (e/f):

e/f=I2/I1 (XI)

Proportion of CO₂ incorporation (% by wt) in polyether ester carbonate polyol A:

$${CO}_{2} incorporation ( \% by wt ) = [ \frac{( \frac{I 2}{3} ) * 44}{( \frac{I 1}{3} + 58 ) + ( \frac{I 2}{3} * 102 ) + ( \frac{I 2}{6} * 144 )} ] * 100 \qquad ( XII )$$

Proportion of lactide incorporation (% by wt) in the polyether ester carbonate polyol A:

$$Lactide incorporation ( \% by wt ) = [ \frac{( \frac{I 5}{3} ) * 144}{( \frac{I 1}{3} * 58 ) + ( \frac{I 2}{3} * 102 ) + ( \frac{I 5}{6} * 144 )} ] * 100 \qquad ( XIII )$$

Molar proportion of unconverted propylene oxide (UR_{PO} in mol %) based on the sum of the amount of propylene oxide employed in the activation and the copolymerization is calculated by the formula:

$$U {R}_{P O} = [ \frac{I 4}{( \frac{I 1}{3} ) + ( \frac{I 2}{3} ) + ( \frac{I 3}{3} ) + ( I 4 ) + ( \frac{I 5}{6} ) + ( \frac{I 6}{6} )} ] * 100 \qquad ( XIV )$$

Molar proportion of unconverted lactide (UR_{lactide} in mol %) based on the sum of the amount of lactide employed in the activation and the copolymerization is calculated by the formula:

$$U {R}_{lactide} = [ \frac{( \frac{I 6}{6} )}{( \frac{I 1}{3} ) + ( \frac{I 2}{3} ) + ( \frac{I 3}{3} ) + ( I 4 ) + ( \frac{I 5}{6} ) + ( \frac{I 6}{6} )} ] * 100 \qquad ( XV )$$

Proportion of CO₂ incorporation (% by wt) in polyether ester carbonate polyols B:

$${CO}_{2} incorporation ( \% by wt ) = [ \frac{( \frac{I 2}{3} ) * 44}{( \frac{I 1}{3} * 58 ) + ( \frac{I 2}{3} * 102 ) + ( \frac{I 7}{6} * 98 )} ] * 100 \qquad ( XVI )$$

Proportion of MA incorporation (% by wt) in polyether ester carbonate polyols B:

$$MA incorporation ( \% by wt ) = [ \frac{( \frac{I 7}{3} ) * 98}{( \frac{I 1}{3} * 58 ) + ( \frac{I 2}{3} * 102 ) + ( \frac{I 7}{6} * 98 )} ] * 100 \qquad ( XVII )$$

OH number (hydroxyl number) was determined according to DIN 53240-2 (November 2007). The number-average Mₙ and the weight-average M_{w} of the molecular weight of the resulting polyetherester carbonate polyol was determined by gel permeation chromatography (GPC). The procedure according to DIN 55672-1 (August 2007): “Gel Permeation Chromatography, Part 1-Tetrahydrofuran as eluent” was followed (SECurity GPC system from PSS Polymer Service, flow rate 1.0 ml/min; columns: 2×PSS SDV linear M, 8×300 mm, 5 μm; RID detector). Polystyrene samples of known molar mass were used for calibration. Polydispersity was calculated as the ratio M_{w}/Mₙ.

### Example 1: Polyetherester Carbonate Polyol Having a Functionality of 2.0 by Terpolymerization of a Mixture of Propylene Oxide, 20% by Weight of Lactide and CO₂

### Step (α)

A 300 ml pressure reactor equipped with a sparging stirrer was initially charged with a mixture of DMC catalyst (18 mg) and PET-I (30 g) and this initial charge was stirred (800 rpm) at 130° C. for 30 minutes under a partial vacuum (50 mbar) while passing argon through the reaction mixture.

### Step (β)

Following injection of 15 bar of CO₂, whereupon a slight drop in temperature was observed, and re-establishment of a temperature of 130° C., 3.0 g of a monomer mixture (20% by weight of lactide dissolved in propylene oxide) was metered in using an HPLC pump (1 ml/min). The reaction mixture was stirred (800 rpm) at 130° C. for 20 min. The addition of 3.0 g of the monomer mixture was repeated a second and third time.

### Step (γ)

The temperature was readjusted to 105° C. and, during the subsequent steps, the pressure in the pressure reactor was kept at 15 bar using a mass flow regulator by metered addition of further CO₂. With stirring, a further 51.0 g of a monomer mixture (20% by weight of lactide dissolved in propylene oxide) were metered in via an HPLC pump (1 mL/min) with continued stirring of the reaction mixture (800 rpm). Once the addition of monomer mixture (20% by weight of lactide dissolved in propylene oxide) was terminated the reaction mixture was stirred at 105° C. for a further 30 min. The reaction was terminated by cooling the pressure reactor in an ice bath, releasing the positive pressure and analyzing the resulting product. The properties of the obtained polyether ester carbonate polyols are shown in table 1.

### Example 2: Polyetherester Carbonate Polyol with a Functionality of 2.0 by Terpolymerization of a Mixture of Propylene Oxide, 20% by Weight Maleic Anhydride and CO₂

### Step (α)

A 300 ml pressure reactor equipped with a sparging stirrer was initially charged with a mixture of DMC catalyst (18 mg) and PET-I (30 g) and this initial charge was stirred (800 rpm) at 130° C. for 30 minutes under a partial vacuum (50 mbar) while passing argon through the reaction mixture.

### Step (β)

Following injection of 15 bar of CO₂, whereupon a slight drop in temperature was observed, and re-establishment of a temperature of 130° C., 3.0 g of a monomer mixture (20% by weight of maleic anhydride dissolved in propylene oxide) was metered in using an HPLC pump (1 ml/min). The reaction mixture was stirred (800 rpm) at 130° C. for 20 min. The addition of 3.0 g of the monomer mixture was repeated a second and third time.

### Step (γ)

The temperature was readjusted to 105° C. and, during the subsequent steps, the pressure in the pressure reactor was kept at 15 bar using a mass flow regulator by metered addition of further CO₂. With stirring, a further 51.0 g of a monomer mixture (20% by weight of maleic anhydride dissolved in propylene oxide) were metered in via an HPLC pump (1 mL/min) with continued stirring of the reaction mixture (800 rpm). Once the addition of monomer mixture (20% by weight of maleic anhydride dissolved in propylene oxide) was terminated the reaction mixture was stirred at 105° C. for a further 30 min. The reaction was terminated by cooling the pressure reactor in an ice bath, releasing the positive pressure and analyzing the resulting product. The properties of the obtained polyether ester carbonate polyols are shown in table 1.

TABLE 1
Comparison of results from Examples 1 and 2

| Example | 1 | 2* |
|---|---|---|
| Selectivity g/e | 0.05 | 0.03 |
| Monomer mixture | 20% by weight | 20% by weight |
| | lactide in PO | MA in PO |
| CO₂ incorporation | 11.2 | 13.1 |
| [% by wt] | | |
| Mₙ [g/mol] | 4223 | 4173 |
| PDI | 1.1 | 1.1 |
| OH number | 36.5 | 34.6 |
| [mg KOH/g] | | |
| Viscosity [mPas] | 3917 | 12325 |

*comparative example

The polyether ester carbonate polyol prepared by addition of lactide (example 1) has a lower viscosity than polyether ester carbonate polyols without addition of lactide (example 2).

1. A process for preparing polyether ester carbonate polyols by catalytic addition of alkylene oxide and carbon dioxide onto an H-functional starter substance in the presence of a double metal cyanide catalyst, comprising:
(α) initially charging a subamount of H-functional starter substance and/or a suspension medium having no H-functional groups into a reactor; and,
(γ) metering the alkylene oxide into the reactor during the reaction,
wherein lactide is metered into the reactor in step (γ).

2. The process as claimed in claim 1, wherein step (α) is carried out in the absence of lactide.

3. The process as claimed in claim 1, wherein the lactide is employed in an amount of 5% by weight to 40% by weight based on the total amount of employed alkylene oxide.

4. The process as claimed in claim 1, wherein the lactide is employed in an amount of 10% by weight to 30% by weight based on the total amount of employed alkylene oxide.

5. The process as claimed in claim 1, wherein following step (α)
(β) a portion of alkylene oxide is added to the mixture from step (α) at temperatures of 90° C. to 150° C. and the addition of the alkylene oxide compound and/or the lactide is subsequently interrupted.

6. The process as claimed in claim 1, wherein in step (γ) the H-functional starter substance, the alkylene oxide and the lactide are continuously metered into the reactor in the presence of carbon dioxide.

7. The process as claimed in claim 1, wherein in step (γ) the metered addition of the H-functional starter substances is terminated prior to the addition of the alkylene oxide and/or of the lactide.

8. The process as claimed in claim 1, wherein in step (γ) H-functional starter substance, alkylene oxide, lactide and double metal cyanide catalyst are continuously metered into the reactor and the resulting reaction mixture is continuously removed from the reactor.

9. The process as claimed in claim 8, wherein the double metal cyanide catalyst is continuously added in the form of a suspension in H-functional starter substance.

10. The process as claimed in claim 8, wherein in a step (δ) downstream of step (γ) the reaction mixture removed continuously in step (γ) having an alkylene oxide content of 0.05% to 10% by weight is transferred into a postreactor and therein subjected to a postreaction, thus reducing the content of free alkylene oxide to less than 0.05% by weight in the reaction mixture.

11. The process as claimed in claim 1, wherein the lactide employed is at least one compound of formula (II), 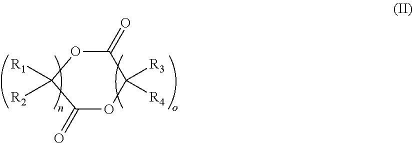
wherein R1, R2, R3 and R4 independently represent hydrogen, a linear or branched C1 to C22 alkyl radical optionally containing heteroatoms, a linear or branched, mono- or polyunsaturated C1 to C22 alkenyl radical optionally containing heteroatoms or an optionally mono- or polysubstituted C6 to C18 aryl radical optionally containing heteroatoms or may be members of a saturated or unsaturated 4- to 7-membered ring or polycyclic ring system optionally containing heteroatoms and/or ether groups,
and n and o independently represent an integer of not less than 1, and R1 and R2 in repeating units (n>1) and R3 and R4 in repeating units (o>1) may be different in each case.

12. The process as claimed in claim 1, wherein the lactide is at least one compound selected from the group consisting of 1,4-dioxane-2,5-dione, (S,S)-3,6-dimethyl-1,4-dioxane-2,5-dione, (R,R)-3,6-dimethyl-1,4-dioxane-2,5-dione, meso-3,6-dimethyl-1,4-dioxane-2,5-dione, 3-methyl-1,4-dioxane-2,5-dione, 3-hexyl-6-methyl-1,4-dioxane-2,5-dione, and 3,6-di(but-3-en-1-yl)-1,4-dioxane-2,5-dione, in each case including optically active forms.

13. The process as claimed in claim 1, wherein the H-functional starter substance is selected from the group consisting of alcohols, amines, thiols, amino alcohols, thio alcohols, hydroxy esters, polyether polyols, polyester polyols, polyester ether polyols, polycarbonate polyols, polyether carbonate polyols, polyethyleneimines, polyetheramines, polytetrahydrofurans, polyether thiols, polyacrylate polyols, castor oil, the mono- or diglyceride of castor oil, monoglycerides of fatty acids, chemically modified mono-, di- and/or triglycerides of fatty acids and C1-C24-alkyl fatty acid esters containing on average at least 2 OH groups per molecule.

14. The process as claimed in claim 1, wherein the H-functional starter substance is selected from the group consisting of ethylene glycol, propane-1,2-diol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, di- and trifunctional polyether polyols and mixtures thereof, wherein the polyether polyol has been formed from a di- or tri-H-functional starter substance and propylene oxide or a di- or tri-H-functional starter substance, propylene oxide and ethylene oxide and the polyether polyol has a molecular weight Mₙ in the range from 62 to 4500 g/mol and a functionality of 2 to 3.

15. The process as claimed in claim 1, wherein the suspension medium having no H-functional groups is selected from the group consisting of 4-methyl-2-oxo-1,3-dioxolane, 1,3-dioxolane-2-one and mixtures of 4-methyl-2-oxo-1,3-dioxolane and 1,3-dioxolane-2-one.

16. The process as claimed in claim 1, wherein step (α) comprises
(α) initially charging a subamount of H-functional starter substance and/or a suspension medium having no H-functional groups into a reactor, together with DMC catalyst.

17. The process as claimed in claim 1, wherein step (γ) comprises
(γ) metering the alkylene oxide and carbon dioxide into the reactor during the reaction.

18. The process as claimed in claim 5, wherein step (β) is performed under an inert gas atmosphere, under an atmosphere of an inert gas-carbon dioxide mixture or under a carbon dioxide atmosphere.

19. The process as claimed in claim 11, wherein n and o independently represent an integer of 1, 2, 3 or 4.
